(19) United States
(12) Patent Application Publication
(10) Pub. No.: US 2024/0126318 A1
(43) Pub. Date: Apr. 18, 2024

(54) BRAKE MECHANISM, MOVABLE FRAME AND BABY CARRIER

(71) Applicant: Wonderland Switzerland AG, Steinhausen (CH)

(72) Inventor: Jialiang YUAN, Dongguan (CN)

(73) Assignee: Wonderland Switzerland AG, Steinhausen (CH)

(21) Appl. No.: 18/483,887

(22) Filed: Oct. 10, 2023

(30) Foreign Application Priority Data
Oct. 12, 2022 (CN) 202211249233.6

(51) Int. Cl. G05G 1/44; B62B 9/08; F16D 63/00; G05G 1/46

(52) U.S. Cl. CPC G05G 1/44; B62B 9/082; B62B 9/087; F16D 63/006; G05G 1/46

(57) ABSTRACT

Disclosed are a brake mechanism, a movable frame, and a baby carrier. The brake mechanism includes a brake driving member and a brake pedal. The brake pedal is detachably connected to the brake driving member.

### CROSS-REFERENCE TO RELATED APPLICATION

The present application claims the priority of Chinese Patent Application No. 202211249233.6, filed on Oct. 12, 2022, entitled “BRAKE MECHANISM, MOVABLE FRAME AND BABY CARRIER”, which is hereby incorporated by reference in its entirety.

### TECHNICAL FIELD

The present disclosure relates to the field of baby products, in particular to a brake mechanism, a movable frame and a baby carrier.

### BACKGROUND

A baby carrier having a movable frame, such as a baby stroller, is conventionally provided with a brake mechanism for braking the wheels to avoid an unwanted movement of the baby carrier. A conventional brake mechanism includes a brake pedal, a brake driving member, a brake rod, and a locking pin. The brake pedal and the brake driving member are an integral mechanism fitting over a transverse tube of the movable frame. The brake driving member is operatively connected to a locking pin through a brake rod. The locking pin is arranged corresponding to a wheel. When the wheel needs to be braked, a user steps on the brake pedal, and the brake driving member rotates around the axis of the transverse tube and simultaneously drives the brake rod to move, and the locking pin moves along with the brake rod and locks the wheel.

For the convenience of the transportation of the baby carrier, conventionally, the movable frame of the baby carrier is foldable. After the movable frame is folded, the pedal is generally in a sloping position and protrudes outwards relative to the folded frame, thus causing a comparatively large volume of the folded movable frame.

### SUMMARY

The present disclosure provides a brake mechanism which is beneficial to a decrease of the volume of a folded movable frame. The present disclosure also provides a movable frame and a baby carrier.

In one aspect, the present disclosure provides a brake mechanism including a brake driving member and a brake pedal. The brake pedal is detachably connected to the brake driving member.

In some embodiments, the brake driving member is configured to engage with the brake pedal.

In some embodiments, one of the brake driving member and the brake pedal has a male plug-in part, and another of the brake driving member and the brake pedal has a female plug-in part; and the male plug-in part is configured to engage with the female plug-in part.

In some embodiments, the brake driving member has a rotation axis. The brake driving member is configured to, when being driven by the brake pedal, rotate around the rotation axis. The brake pedal includes a pedal part and an annular part. The annular part is configured to fit over the brake driving member and move along the rotation axis to be detached from the brake driving member.

In some embodiments, the annular part and the brake driving member engages with each other by a tight fit, or a rotation restricting mechanism is arranged between the annular part and the brake driving member.

In some embodiments, the rotation restricting mechanism includes: a positioning rib extending along the rotation axis, and a positioning groove configured to engage with the positioning rib. The positioning rib is arranged on an outer periphery of the brake driving member, and the positioning groove is arranged on an inner wall of the annular part; or the positioning rib is arranged on the inner wall of the annular part, and the positioning groove is arranged on the outer periphery of the brake driving member.

In some embodiments, the number of positioning ribs is multiple, and the multiple positioning ribs include a first positioning rib, a second positioning rib and a third positioning rib. The first positioning rib, the second positioning rib and the third positioning rib are arranged at intervals in a circumferential direction, and configured to satisfy at least one of: (a) a width of the first positioning rib, a width of the second positioning rib and a width of the third positioning rib are unequal; and (b) a height of the first positioning rib, a height of the second positioning rib and a height of the third positioning rib are unequal.

In some embodiments, the number of positioning grooves is multiple, and the multiple positioning grooves include a first positioning groove, a second positioning groove, and a third positioning groove. The first positioning groove, the second positioning groove and the third positioning groove engage with the first positioning rib, the second positioning rib and the third positioning rib, respectively.

In some embodiments, an axial positioning mechanism is arranged between the annular part and the brake driving member.

In some embodiments, the axial positioning mechanism includes: an elastic arm extending along the rotation axis, and a recess configured to engage with the protrusion arranged on the elastic arm. A protrusion is arranged on an end of the elastic arm. The elastic arm is arranged on the brake driving member, and the recess is arranged on the annular part. Or the recess is arranged on the brake driving member, and the elastic arm is arranged on the annular part.

In some embodiments, the brake mechanism further includes a guide groove configured to guide the elastic arm to slide. The guide groove is arranged on an inner wall of the annular part corresponding to the elastic arm arranged on the brake driving member. Or the guide groove is arranged on an outer periphery of the brake driving member corresponding to the elastic arm arranged on the annular part.

In some embodiments, a groove depth of the guide groove becomes gradually smaller in a direction along which the elastic arm is inserted into the guide groove, and the groove depth of the guide groove is a dimension of the guide groove in a radial direction of the brake driving member.

In some embodiments, the elastic arm is arranged on the brake driving member, and the recess is a through hole formed in the annular part.

In some embodiments, the annular part has a first circumferential position and a second circumferential position with respect to the brake driving member. The brake pedal is configured to drive the brake driving member to rotate when the annular part is in the first circumferential position, and configured to rotate to a state of not protruding outwards when the annular part is in the second circumferential position.

In another aspect, the present disclosure provides a movable frame having the brake mechanism described above.

In some embodiments, the movable frame includes a transverse tube and wheels. The transverse tube is arranged between two wheels, and two ends of the transverse tube are rotatably connected to the two wheels, respectively. The brake driving member is configured to fit over the transverse tube. The brake mechanism further includes a fixing seat, a brake rod and a locking pin, and the brake driving member is operatively connected to the locking pin through the brake rod.

In some embodiments, the brake pedal is configured to, after being detached from the brake driving member, be rotatably arranged on the transverse tube.

In yet another aspect, the present disclosure provides a baby carrier including the movable frame described above.

### BRIEF DESCRIPTION OF THE DRAWINGS

FIG. 1 illustratively shows a perspective view of a baby carrier, provided with a movable frame of an embodiment of the present disclosure, in accordance with an embodiment of the present disclosure;

FIG. 2 illustratively shows a perspective view of a frame body of the movable frame in a folded state in accordance with an embodiment of the present disclosure, where the movable frame is provided with a brake mechanism of an embodiment of the present disclosure;

FIG. 3 illustratively shows a perspective view in one direction of the brake mechanism and a transverse tube in accordance with an embodiment of the present disclosure;

FIG. 4 illustratively shows a perspective view in another direction of the brake mechanism and the transverse tube in accordance with another embodiment of the present disclosure;

FIG. 5 illustratively shows a perspective view of a partial structure of the movable frame in accordance with an embodiment of the present disclosure, where a brake pedal of the brake mechanism is detached from a brake driving member;

FIG. 6 illustratively shows a perspective view of the brake pedal and the brake driving member of the brake mechanism which are detached from each other in accordance with an embodiment of the present disclosure;

FIG. 7 illustratively shows a perspective view of the brake driving member of the brake mechanism mounted on the transverse tube in accordance with an embodiment of the present disclosure;

FIG. 8 illustratively shows another perspective view of the brake driving member of the brake mechanism mounted on the transverse tube in accordance with another embodiment of the present disclosure;

FIG. 9 illustratively shows a perspective view of the brake driving member of the brake mechanism in accordance with an embodiment of the present disclosure;

FIG. 10 illustratively shows a front view of the brake pedal of the brake mechanism in accordance with an embodiment of the present disclosure; and

FIG. 11 illustratively shows a perspective view of the brake pedal of the brake mechanism in accordance with an embodiment of the present disclosure.

### DETAILED DESCRIPTION OF THE EMBODIMENTS

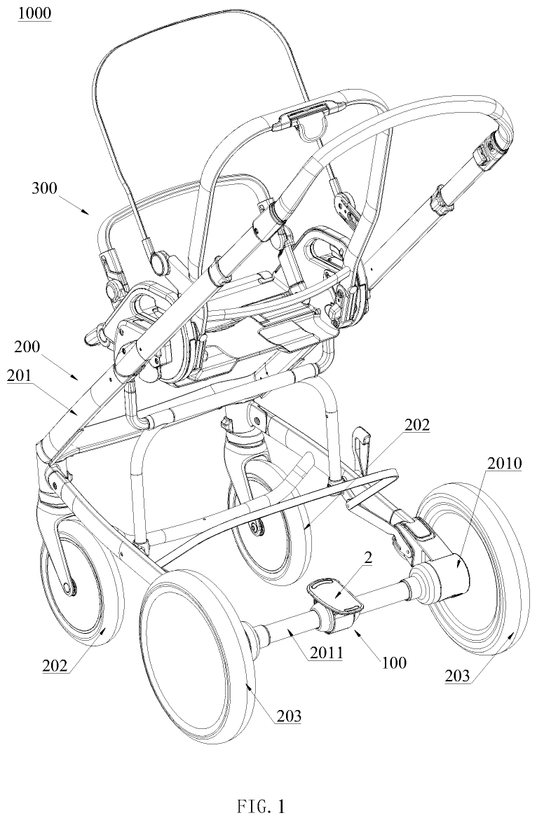

FIG. 1 shows a perspective view of a baby carrier 1000 in accordance with an embodiment of the present disclosure. The baby carrier 1000 is illustrated by taking a stroller as an example, but the type of the baby carrier 1000 is not limited to the stroller. In other exemplary embodiments, the baby carrier 1000 may be a baby dining chair, a baby game bed, etc. As shown in the figure, the baby carrier 1000 includes a movable frame 200, and a seat 300 mounted on the movable frame 200. The movable frame 200 is provided with a brake mechanism 100 in accordance with an embodiment of the present disclosure.

Referring to FIG. 1, the structure of the movable frame 200 selectively presents a left-and-right symmetry. The movable frame 200 includes a frame body 201, and wheels mounted on the bottom of the frame body 201. The wheels include two left and right wheels 202 disposed at the front, and two left and right wheels 203 disposed at the rear. A transverse tube 2011 is disposed, for example, at the rear of the frame body 201 and arranged between two wheels 203, and two ends of the transverse tube 2011 are rotatably connected to the two wheels 203, respectively. In some embodiments, the transverse tube 2011 is disposed at the front of the frame body 201 and arranged between the two wheels 202, and two ends of the transverse tube 2011 are rotatably connected to the two wheels 202, respectively.

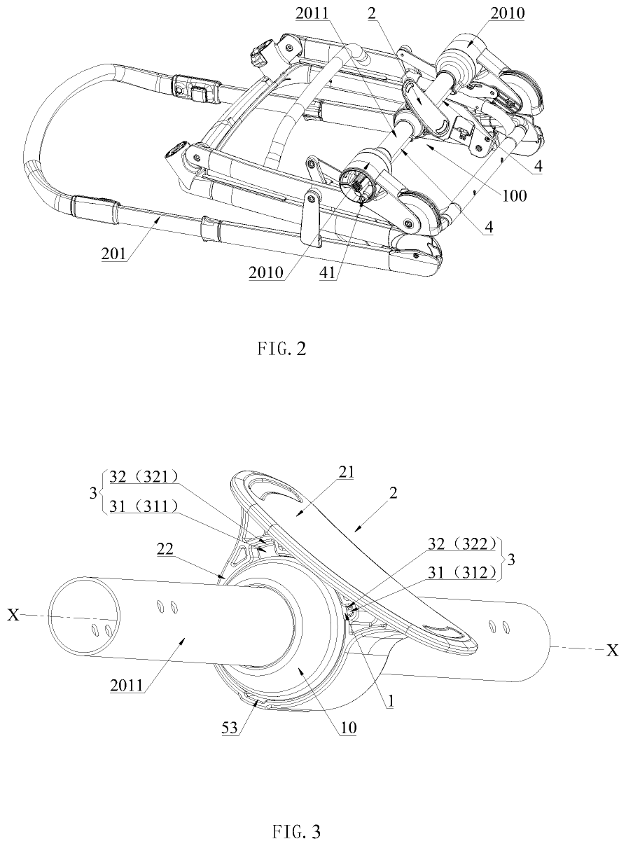

As shown in FIG. 5, the brake driving member 1 and the brake pedal 2 of the brake mechanism 100 are arranged on the transverse tube 2011, and the brake mechanism 100 is configured to brake the wheel 203. Referring to FIG. 2, the frame body 201 is detachably connected to the seat 300, and the frame body 201 is foldable.

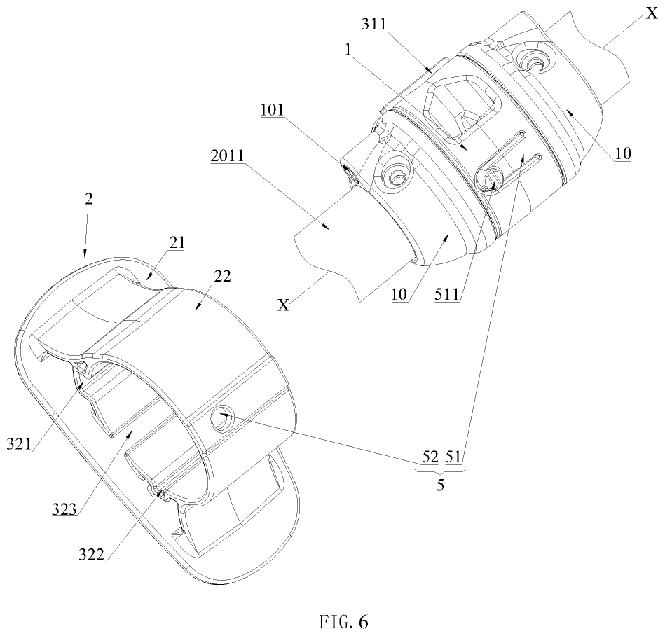

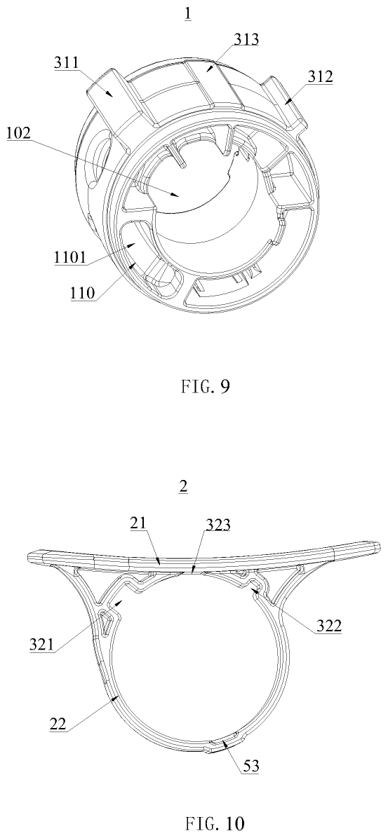

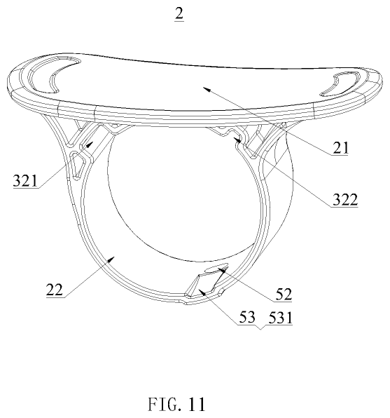

Referring to FIGS. 5 and 6, the brake mechanism 100 includes the brake driving member 1 and the brake pedal 2. In some embodiments, the brake driving member 1 fits over the transverse tube 2011 through a central hole 102 of the brake driving member 1 (shown in FIG. 9), and thus having a rotation axis X-X which is substantially coincident with an axis of the transverse tube 2011. The brake driving member 1 is operatively connected to a locking pin 41 of the brake mechanism 100 (shown in FIG. 2). In some embodiments, the brake driving member 1, when being driven by the brake pedal 2, rotates around the rotation axis X-X and simultaneously drives the locking pin 41 to lock the wheel 203. For the operatively achieved connection between the brake driving member 1 and the locking pin 41, a reference may be made to the relevant art. An exemplary connection structure between the brake driving member 1 and the locking pin 41 is also be described hereinafter.

Referring to FIG. 2, FIG. 3, FIG. 5 and FIG. 6, the brake pedal 2 includes a pedal part 21 and an annular part 22. The pedal part 21 is configured for a user to directly step on, and the annular part 22 is disposed at one side of the pedal part 21. The brake pedal 2 detachably fits over the brake driving member 1 by means of the annular part 22. Referring to FIG. 1, when the movable frame 200 is unfolded for a baby to be seated, the brake pedal 2 fits over the brake driving member 1 and is in a normal state. When receiving a pressing force from the user, the brake pedal 2 drives the brake driving member 1 to rotate together with the brake pedal 2 around the rotation axis X-X The rotation of the brake driving member 1, as described above, drives the locking pin 41 to be inserted into a locking hole (not shown in the figures) of the wheel 203, so that the brake mechanism 100 is switched from a brake releasing state to a braking state.

Referring to FIG. 2, when the movable frame 200 is folded for packaging or storage, if the brake pedal 2 fits over the brake driving member 1 in a way of being in a normal state, the brake pedal 2 excessively protrudes outwards relative to the frame body 201, which is not conducive to a decrease of the volume of the folded movable frame 200. At this time, an axial force may be applied to the annular part 22 of the brake pedal 2 to force the annular part 22 to move along the rotation axis X-X, until the annular part 22 completely disengages from the brake driving member 1 and is suspended from the transverse tube 2011. It may be understood that the brake pedal 2 suspended from the transverse tube 2011 may move freely along the rotation axis X-X to adjust a position.

The brake driving member 1 and the brake pedal 2 of the brake mechanism 100 of the above embodiments of the present disclosure are configured to be separate structures which are detachably connected. When the movable frame 200 in a folded state is delivered from a factory, the brake pedal 2 may be detached from the brake driving member 1 and suspended from the transverse tube 2011, In this case, the brake pedal 2 may be rotated to any suitable position without excessively protruding outwards relative to the frame body 201, which is beneficial to the decrease of the volume of the folded frame body 201, thereby saving a packaging cost. Additionally, the brake pedal 2 suspended from the transverse tube 2011 is not easily lost. After receiving the movable frame 200, the user may have the brake pedal 2 fit over the brake driving member 1 by themself, so that the brake pedal 2 and the brake mechanism 100 may be used normally.

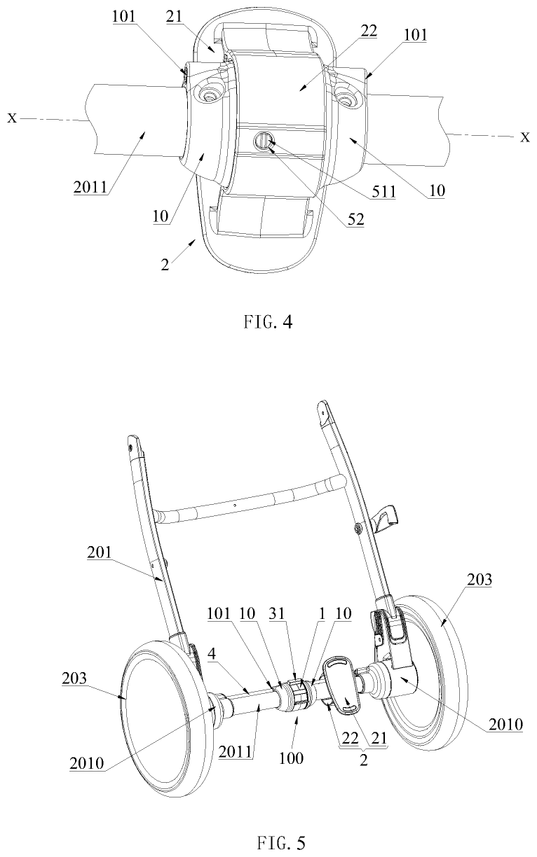

Referring to FIG. 2, FIG. 4, FIG. 5 and FIG. 9, an exemplary connection structure operatively achieved between the brake driving member 1 and the locking pin 41 is illustrated in the embodiment. The brake mechanism 100 includes a fixing seat 10 and a brake rod 4. The fixing seat 10 is, for example, fixed on the transverse tube 2011 and arranged on one side of the brake driving member 1. The brake rod 4 is disposed outside the transverse tube 2011 and is parallel to the transverse tube 2011, and is arranged between the fixing seat 10 and the wheel 203 which are located on the same side of the brake driving member 1. As shown in FIG. 2, a first end of the brake rod 4 is, for example, inserted into a wheel seat 2010 for mounting the wheel 203, of the movable frame 200. The locking pin 41 is disposed at the first end of the brake rod 4 and adapted to engage with a locking hole of the wheel 203. In this embodiment, the locking pin 41 is a portion of the brake rod 4. In some embodiments not shown, the locking pin 41 may be parallel to the brake rod 4, and in this case, the locking pin 41 and the brake rod 4 may be connected by a bent arm. As shown in FIG. 9, a second end of the brake rod 4 is configured to pass through a hole 101 of the fixing seat 10 and then extend into a sliding groove 110 formed on the brake driving member 1, and the second end of the brake rod 4 abuts against a bottom wall 1101 of the sliding groove 110. A depth of the sliding groove 110 gradually becomes larger or smaller in a circumferential direction of the brake driving member 1, such that the bottom wall 1101 of the sliding groove 110 is a sloping wall. A direction of the depth of the sliding groove 110 is parallel to the axial direction of the transverse tube 2011. In some embodiments, the number of the fixing seats 10, the number of the brake rods 4 and the number of the locking pins 41 are all two. The brake driving member 1 is disposed between two fixing seats 10, and an axial position of the brake driving member 1 is restricted by the two fixing seats 10. Two brake rods 4 each are arranged between a fixing seat 10 and a wheel 203 which are arranged on the same side of the brake driving member 1, and the brake driving member 1 is operatively connected to the two locking pins 41 respectively by the two brake rods 4.

In some embodiments, when a user wants to brake a wheel, the user depresses the brake pedal 2, the brake driving member 1 rotates together with the brake pedal 2, and the bottom wall 1101 of the sliding groove 110 pushes the brake rod 4 to move towards the wheel 203, so that the locking pin 41 can be inserted into the locking hole of the wheel 203, and the brake mechanism 100 goes into a braking state. In some embodiments, the brake mechanism 100 is also provided with an elastic restoring member (not shown in the figures). When the braked wheel needs to be released, the user may lift the brake pedal 2 up by toes, and the brake rod 4, under the action of the elastic restoring member, drives the locking pin 41 to retract from the locking hole of the wheel 203, and the brake mechanism 100 is restored to the brake releasing state. The elastic restoring member is, for example, a spring, which is arranged between the brake rod 4 and the wheel seat 2010.

In some embodiments not shown, when the annular part 22 of the brake pedal 2 fits over the brake driving member 1, the annular part 22 engages with the brake driving member 1 by means of a tight fit, such that the brake driving member 1 rotates together with the brake pedal 2 when a force is applied to the brake pedal 2 to force it to rotate. In some embodiments, an inner surface of the annular part 22 and/or an outer surface of the brake driving member 1 may be covered with a layer of an elastic material having a high frictional coefficient, and the annular part 22 and the brake driving member 1 abut against each other by means of the elastic material layer to achieve a tight fit of the annular part 22 and the brake driving member 1.

Referring to FIG. 3, in some embodiments, a rotation restricting mechanism 3 is arranged between the annular part 22 and the brake driving member 1. The rotation restricting mechanism 3 is configured to restrict a relative rotation between the annular part 22 and the brake driving member 1, so as to avoid a slide between the brake driving member 1 and the brake pedal 2 when the brake pedal 2 is depressed. In some exemplary embodiments, the rotation restricting mechanism 3 includes at least one positioning rib 31 and at least one positioning groove 32. The positioning rib 31 is arranged on the outer periphery of the brake driving member 1, and the positioning groove 32 is formed on the inner wall of the annular part 22. Each positioning rib 31 and each positioning groove 32 extend along the rotation axis X-X. The positioning ribs 31 and the corresponding positioning grooves 32 engages with each other, such that the relative rotation between the annular part 22 and the brake driving member 1 can be restricted. In some alternative embodiments, the position of the positioning rib 31 on the brake driving member 1 and the position of the positioning groove 32 on the annular part 22 may be interchanged. In other alternative embodiments, a positioning rib 31, together with a positioning groove 32, is arranged on the outer periphery of the brake driving member 1, and correspondingly, a positioning groove 32, together with a positioning rib 31, is formed on the inner wall of the annular part 22.

In some exemplary embodiments, the rotation restricting mechanism 3 is provided with a plurality of positioning ribs 31 and a plurality of positioning grooves 32. The plurality of positioning ribs 31 are arranged at intervals in the circumferential direction, and the plurality of positioning grooves 32 are distributed corresponding to the plurality of positioning ribs 31, respectively, so that the stresses exerted on the annular part 22 and the brake driving member 1 can be improved. In some exemplary embodiments, widths and/or heights of the plurality of positioning ribs 31 are equal. In some exemplary embodiments, the widths and/or the heights of the plurality of positioning ribs 31 may be configured to be unequal as required.

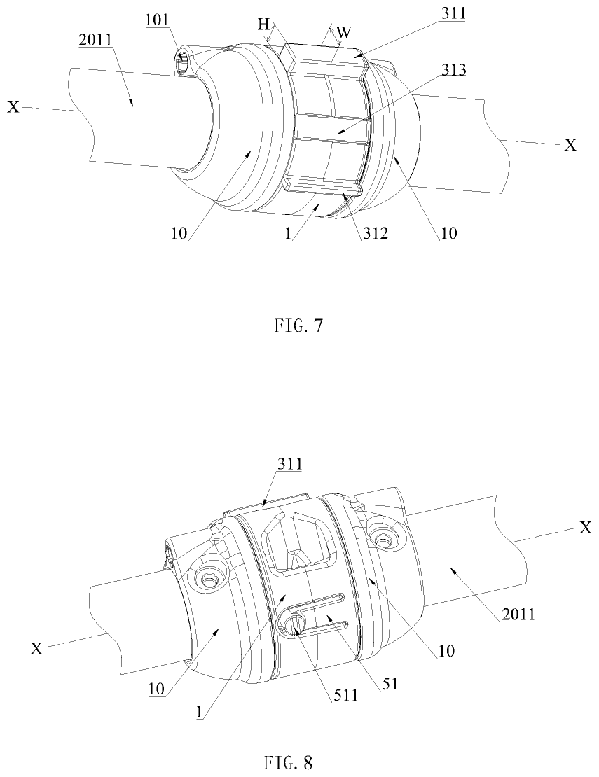

Referring to FIGS. 3 and 7, in some exemplary embodiments, the plurality of positioning ribs 31 include a first positioning rib 311, a second positioning rib 312, and a third positioning rib 313. Referring to FIGS. 3 and 6, the plurality of positioning grooves 32 correspondingly include a first positioning groove 321, a second positioning groove 322, and a third positioning groove 323. Referring to FIG. 7, a width W and a height H of the first positioning rib 311 are larger than a width and a height of the second positioning rib 312, respectively, and the width W and the height H of the first positioning rib 311 are also larger than a width and a height of the third positioning rib 313, respectively. The plurality of positioning ribs 31 are configured to have different sizes, which makes it convenient for the user to align the annular part 22 with the brake driving member 1, so that the annular part 22 can fit over the brake driving member 1. In some embodiments, at least one positioning rib 31 is arranged adjacent to a junction of the pedal part 21 and the annular part 22, so that a driving force from the pedal part 21 may be transferred to the brake driving member 1 at a close distance.

In some exemplary embodiments not shown, the annular part 22 has a first circumferential position and a second circumferential position with respect to the brake driving member 1 by appropriately arranging the positions of the positioning ribs 31 and the positions of the positioning grooves 32, and by the positioning ribs 31 selectively engaging with the positioning grooves 32, respectively. As shown in FIG. 1, the first circumferential position corresponds to, for example, a normal state of the brake pedal 2, and in this case, the user may normally depress the brake pedal 2 to brake the wheel 203. The second circumferential position corresponds to a received state of the brake pedal 2. When the movable frame 200 is folded, the brake pedal 2 may be adjusted to the received state, for example, the brake pedal 2 in the received state corresponds to the brake pedal 2 in the normal state shown in FIG. 2 after rotating for 180 degrees, so that the brake pedal 2 does not protrude excessively relative to the frame body 201, thereby reducing the volume of the folded movable frame 200. When the brake pedal 2 is in the received state, the brake pedal 2 is still located on the brake driving member 1 and will not swing relative to the transverse tube 2011 randomly, which is beneficial to a decrease of collision noise. It may be understood that when the circumferential position of the annular part 22 needs to be changed, the annular part 22 is first moved along the rotation axis X-X to disengage from the brake driving member 1, then the annular part 22 is rotated to a desired circumferential position, and finally the annular part 22 is moved along the rotation axis X-X to fit over the brake driving member 1 again.

Referring to FIG. 6, in some embodiments, an axial positioning mechanism 5 is arranged between the annular part 22 and the brake driving member 1, and the axial positioning mechanism 5 is configured to limit a relative axial movement between the annular part 22 and the brake driving member 1, thus preventing the annular part 22 from accidentally falling off from the brake driving member 1. In some exemplary embodiments, the axial positioning mechanism 5 includes an elastic arm 51 and a recess 52. The elastic arm 51 is arranged on the brake driving member 1. A protrusion 511 is arranged on an end of the elastic arm 51, and the recess 52 is formed on the annular part 22. The recess 52 engages with the protrusion 511, thus restricting the relative axial movement between the annular part 22 and the brake driving member 1. It may be understood that the numbers of the elastic arms 51 and recesses 52 may be configured as required. In some alternative embodiments, the position of the elastic arm 51 on the brake driving member 1 and the position of the recess 52 on the annular part 22 may be interchanged. In other alternative embodiments, both the brake driving member 1 and the annular part 22 have the elastic arms 51 and the recesses 52. When the annular part 22 fits over the brake driving member 1, the protrusions 511 on the respective elastic arms 51 are snapped into respective recesses 52.

Referring to FIG. 4 and FIG. 6, in some embodiments, the recess 52 is a through hole formed in the annular part 22. When the annular part 22 needs to be removed from the brake driving member 1, the user may depress the protrusion 511 manually to force the protrusion 511 to retract from the recess 52, thus the annular part 22 may be easily moved along the rotation axis X-X, thereby separating the annular part 22 from the brake driving member 1.

It should be noted that, in some embodiments, by appropriately configuring the numbers and sizes of the elastic arms 51 and corresponding recesses 52, a relative circumferential rotation between the annular part 22 and the brake driving member 1 may be effectively restricted by the protrusions 511 engaging with the recesses 52. In this case, the positioning rib 31 and the positioning groove 32 described above may not be formed on the brake driving member 1 and the annular part 22.

Referring to FIG. 11, in some embodiments, a guide groove 53 may be formed on the inner wall of the annular part 22, and the number of the guide grooves 53 corresponds to the number of the elastic arms 51. The guide groove 53 is configured to guide an axial slide of the elastic arm 51, so as to facilitate the alignment of the protrusions 511 and the recesses 52. It should be understood that, in some alternative embodiments, when the recess 52 is formed on the brake driving member 1, and the elastic arm 51 is arranged on the annular part 22, correspondingly, the guide groove 53 for guiding the slide of the elastic arm 51 is formed on the outer periphery of the brake driving member 1.

Referring to FIG. 11, a groove depth of the guide groove 53 becomes gradually smaller in the direction along which the elastic arm 51 is inserted into the guide groove 53, wherein the groove depth of the guide groove 53 is a dimension of the guide groove 53 in a radial direction of the brake driving member 1, that is, the bottom wall 531 of the guide groove 53 is a sloping wall, such that the protrusion 511 of the elastic arm 51 may be more easily inserted into the guide groove 53.

It should be noted that the brake mechanism 100 provided by the above embodiments of the present disclosure is not limited to the above examples, but may have any other structure, as long as it can reduce the influence of the brake pedal 2 on the sizes of the folded frame body 201. For example, the brake mechanism 100 according to some embodiments of the present disclosure may have following modifications.

In some embodiments, the brake driving member 1 and the brake pedal 2 are arranged on the transverse tube 2011 and may slide linearly along a radial direction of the transverse tube 2011. In this case, the brake driving member 1 abuts against each brake rod 4 through a sloping surface, and an up-and-down movement of the brake driving member 1 corresponds to a left-and-right movement of each brake rod 4, thus forcing the locking pin 41 to be inserted into or to retract from the locking hole of the wheel 203. In this case, the brake pedal 2 may not be provided with the annular part 22, but may detachably engage with the brake driving member 1 through any suitable mechanism. For example, one of the brake driving member 1 and the brake pedal 2 has a male plug-in part, such as a plug with an elastic arm, and another of the brake driving member 1 and the brake pedal 2 has a female plug-in part, such as a slot. The male plug-in part and the female plug-in part may detachably engage, so that the brake pedal 2 may be connected to or detached from the brake driving member 1 as required.

In some embodiments, the brake driving member 1 and the brake pedal 2 may be an integral mechanism, and the brake pedal 2 may be folded so as not to protrude excessively relative to the folded frame body 201. In some exemplary embodiments not shown, a pedal part 21 of the brake pedal 2 includes two sub-pedal parts which are connected by a pivot. An axial direction of the pivot is perpendicular to the rotation axis X-X. The two sub-pedal parts may be pivoted to a folded state and pivoted to overlap each other to reduce their own volume, or may be pivoted to an open state for a user to depress.

In some embodiments, the brake rod 4 may be replaced with a cable or any other suitable traction member which is configured to pass through the transverse tube 2011, and which is within the scope of the present disclosure as well. In some embodiments, when the brake rod 4 is replaced with the cable, a sliding groove axially extending is formed on one of the brake driving member 1 and the transverse tube 2011, and a sloping groove is formed on the other of the brake driving member 1 and the transverse tube 2011. A first end of the cable is connected to the locking pin, and a second end of the cable is provided with a connecting pin, and the connecting pin is sleeved inside the sliding groove and inside the sloping groove. When the brake pedal 2 and the brake driving member 1 are depressed to rotate, the connecting pin, driven by the sloping groove, moves along the sliding groove, so that the locking pin is driven to be inserted into the locking hole of the wheel 203 through the cable.

In some embodiments, the brake driving member 1 is detachably connected to the brake pedal 2, and the brake pedal 2 is foldable as well, which is also within the protection scope of the present disclosure.

It should be noted that, although the brake mechanism 100 in the embodiments above is described by taking the brake mechanism 100 applied to the movable frame 200 used for the baby carrier 1000 as an example, an application range of the brake mechanism 100 is not limited to the baby carrier 100, but may include various products having movable frame, such as various carts including a supermarket cart, and a carrying cart, etc.

In the present disclosure, on the one hand, the connection between the brake driving member and the brake pedal is configured to be a detachable connection, and on the other hand, the brake pedal may be configured to be foldable. The brake pedal may be separated from the brake driving member, and/or the brake pedal may be folded when the frame body of the movable frame is folded, thus the brake pedal is prevented from excessively protruding outwards relative to the folded frame body, which is beneficial to the decrease of the volume of the folded movable frame, thereby saving the packaging cost.

The technical features of the embodiments above may be arbitrarily combined. For the sake of conciseness, not all possible combinations of various technical features in the embodiments are described. However, as long as there are no contradictions between the combinations of the technical features, these combinations should be within the scope of the specification.

The embodiments above are some examples of the present disclosure, which are described in detail, but should not be understood as limiting the scope of the disclosure. It should be noted that various variations and modifications may be made by those skilled in the art without departing from the concepts of the present disclosure, and these variations and modifications all fall within the scope of the present disclosure. Accordingly, the scope of protection of the present disclosure should be subject to the appended claims.

What is claimed is:

1. A brake mechanism, comprising a brake driving member and a brake pedal, wherein the brake pedal is detachably connected to the brake driving member.

2. The brake mechanism according to claim 1, wherein the brake driving member is configured to engage with the brake pedal.

3. The brake mechanism according to claim 2, wherein one of the brake driving member and the brake pedal has a male plug-in part, and another of the brake driving member and the brake pedal has a female plug-in part; and the male plug-in part is configured to engage with the female plug-in part.

4. The brake mechanism according to claim 2, wherein
the brake driving member has a rotation axis;
the brake driving member is configured to, when being driven by the brake pedal, rotate around the rotation axis;
the brake pedal comprises a pedal part and an annular part; and
the annular part is configured to fit over the brake driving member and move along the rotation axis to be detached from the brake driving member.

5. The brake mechanism according to claim 4, wherein the annular part and the brake driving member engages with each other by a tight fit; or
a rotation restricting mechanism is arranged between the annular part and the brake driving member.

6. The brake mechanism according to claim 5, wherein the rotation restricting mechanism comprises: a positioning rib extending along the rotation axis, and a positioning groove configured to engage with the positioning rib;
wherein the positioning rib is arranged on an outer periphery of the brake driving member, and the positioning groove is arranged on an inner wall of the annular part; or the positioning rib is arranged on the inner wall of the annular part, and the positioning groove is arranged on the outer periphery of the brake driving member.

7. The brake mechanism of claim 6, wherein:
the number of positioning ribs is multiple, and the multiple positioning ribs comprise a first positioning rib, a second positioning rib and a third positioning rib; and
the first positioning rib, the second positioning rib and the third positioning rib are arranged at intervals in a circumferential direction, and configured to satisfy at least one of:
(a) a width of the first positioning rib, a width of the second positioning rib and a width of the third positioning rib are unequal; and
(b) a height of the first positioning rib, a height of the second positioning rib and a height of the third positioning rib are unequal.

8. The brake mechanism according to claim 7, wherein:
the number of positioning grooves is multiple, and the multiple positioning grooves comprise a first positioning groove, a second positioning groove, and a third positioning groove; and
the first positioning groove, the second positioning groove and the third positioning groove engage with the first positioning rib, the second positioning rib and the third positioning rib, respectively.

9. The brake mechanism according to claim 4, wherein an axial positioning mechanism is arranged between the annular part and the brake driving member.

10. The brake mechanism according to claim 9, wherein the axial positioning mechanism comprises: an elastic arm extending along the rotation axis, and a recess configured to engage with a protrusion arranged on the elastic arm; the protrusion is arranged on an end of the elastic arm;
wherein the elastic arm is arranged on the brake driving member, and the recess is arranged on the annular part; or the recess is arranged on the brake driving member, and the elastic arm is arranged on the annular part.

11. The brake mechanism according to claim 10, further comprising a guide groove configured to guide the elastic arm to slide, wherein:
the guide groove is arranged on an inner wall of the annular part corresponding to the elastic arm arranged on the brake driving member; or
the guide groove is arranged on an outer periphery of the brake driving member corresponding to the elastic arm arranged on the annular part.

12. The brake mechanism according to claim 11, wherein a groove depth of the guide groove becomes gradually smaller in a direction along which the elastic arm is inserted into the guide groove, and the groove depth of the guide groove is a dimension of the guide groove in a radial direction of the brake driving member.

13. The brake mechanism according to claim 10, wherein the elastic arm is arranged on the brake driving member, and the recess is a through hole formed in the annular part.

14. The brake mechanism according to claim 4, wherein the annular part has a first circumferential position and a second circumferential position with respect to the brake driving member; the brake pedal is configured to drive the brake driving member to rotate when the annular part is in the first circumferential position, and configured to rotate to a state of not protruding outwards when the annular part is in the second circumferential position.

15. A movable frame, having the brake mechanism according to claim 1.

16. The movable frame according to claim 15, comprising a transverse tube and wheels, wherein:
the transverse tube is arranged between two wheels, and two ends of the transverse tube are rotatably connected to the two wheels, respectively;
the brake driving member is configured to fit over the transverse tube; and
the brake mechanism further comprises a fixing seat, a brake rod and a locking pin, and the brake driving member is operatively connected to the locking pin through the brake rod.

17. The movable frame according to claim 16, wherein the brake pedal is configured to, after being detached from the brake driving member, be rotatably arranged on the transverse tube.

18. A baby carrier, comprising the brake mechanism according to claim 1.

19. A baby carrier, comprising the movable frame according to claim 15.
